(19) United States
(12) Patent Application Publication
(10) Pub. No.: US 2016/0030994 A1
(43) Pub. Date: Feb. 4, 2016

(54) NOTCHER

(71) Applicants: Eric BURKHART, Barnesville, OH (US); FAMOUS INDUSTRIES, INC. D/B/A HEATING & COOLING PRODUCTS COMAPNY, Mount Vernon, OH (US)

(72) Inventors: ERIC BURKHART, BARNESVILLE, OH (US); RON PARRY, (US)

(21) Appl. No.: 14/776,909

(22) PCT Filed: Mar. 17, 2014
(86) PCT No.: PCT/US14/30547

§ 371 Date: Sep. 15, 2015

Related U.S. Application Data
(60) Provisional application No. 61/792,289, filed on Mar. 15, 2013.

(51) Int. Cl. B21D 28/20; F16L 25/00; F16L 21/08; B21D 28/14; B23D 15/14

(52) U.S. Cl. CPC B21D 28/20; B21D 28/14; B23D 15/14; F16L 21/08; F16L 25/0009

(57) ABSTRACT

A notching apparatus includes a stationary die, a notching die, a rod connected to the notching die, a double acting air cylinder connected to the rod for reciprocating the rod and notching die. The double acting air cylinder uses air pressure to both extend and retract the rod. A notching table includes at least one notching apparatus.

### CROSS-REFERENCE TO RELATED APPLICATION

This application is a United States national stage of International Application No. PCT/US2014/030547, filed Mar. 17, 2014, which published as International Publication No. WO 2014/145737, and which claims the benefit under 35 U.S.C. §119(e) of the earlier filing date of U.S. Provisional Patent Application No. 61/792,289 filed on Mar. 15, 2013, which is hereby incorporated by reference.

### FIELD OF INVENTION

This application is generally directed to the field of notchers.

### BACKGROUND

Products used in heating/ventilation/air conditioning (HVAC) units are typically formed of sheet stock such as sheet metal. Examples of metals include steel, aluminum and the like. In particular, pipe or duct work for HVAC units is typically made from one or more sections of sheet stock that are formed to create a conduit. In general, duct work or conduit may have a round and/or rectangular cross section. The sections of steel conduit are joined to create the duct work. Seams are created along each pipe section where the sheet stock is joined resulting in steel against steel joint. Notchers are used to cut out desired portions of the sheet stock. Known prior art notchers rely on a pivot mechanism to move a notching arm with a notching die attached to pierce and cut the metal. The pivot arm is moved by a rod attached to a spring loaded air bladder that inflates to engage the notcher, and the spring pulls the pivot arm back to its original position after the notching process has occurred. These prior art notchers are prone to heavy wear and tear on the rubber bladder, pivot arm, pivot shaft and the pivot pin.

### BRIEF DESCRIPTION OF THE DRAWINGS

Various embodiments of the invention are described herein by way of example in conjunction with the following figures, wherein like reference characters designate the same or similar elements.

FIG. 1 is a schematic view of a portion of a duct system.

FIG. 2 is a cross-sectional view taken along line 2-2 of FIG. 1.

FIG. 3 is a cross-sectional view taken along line 3-3 of FIG. 1.

FIG. 4 is a cross-sectional view taken along line 4-4 of FIG. 1.

FIG. 5 is an isometric projection of a pipe of FIG. 1.

FIG. 6A is a cross-sectional view taken along line 6-6 of FIG. 5.

FIG. 6B is a cross-sectional view taken along line 6-6 of FIG. 5 in a locked conformation in accordance with the embodiment of FIG. 6A.

FIG. 7A is a cross-sectional view taken along line 6-6 of FIG.

FIG. 7B is a cross-sectional view taken along line 6-6 of FIG. 5 in a locked conformation in accordance with the embodiment of FIG. 7B.

FIG. 8 is a cross-sectional view taken along line 4-4 of FIG. 1 in a locked conformation.

FIG. 9 is a flow diagram of a method of fabricating the pipe and fitting coupling system of FIG. 1.

FIG. 10 is a perspective view of embodiments of a notching machine.

FIG. 11 is an end view of embodiments of a notching machine.

FIG. 12 is a sectional perspective view of embodiments of a notcher.

FIG. 13 is a sectional side view of embodiments of a notcher.

FIGS. 14A, 14B, 14C and 14D are perspective views of dies.

FIGS. 15A, 15B, 15C and 15D are top views of dies.

FIG. 16 is a top view of a notched pipe blank.

### DETAILED DESCRIPTION

Before explaining at least one embodiment of the invention in detail, it is to be understood that the invention is not limited in its application to the details of construction and to the arrangements of the components set forth in the following description or illustrated in the drawings and that some embodiments are described by way of reference only. The invention is capable of embodiments in addition to those described and of being practiced and carried out in various ways. Also, it is to be understood that the phraseology and terminology employed herein are for the purpose of description and should not be regarded as limiting.

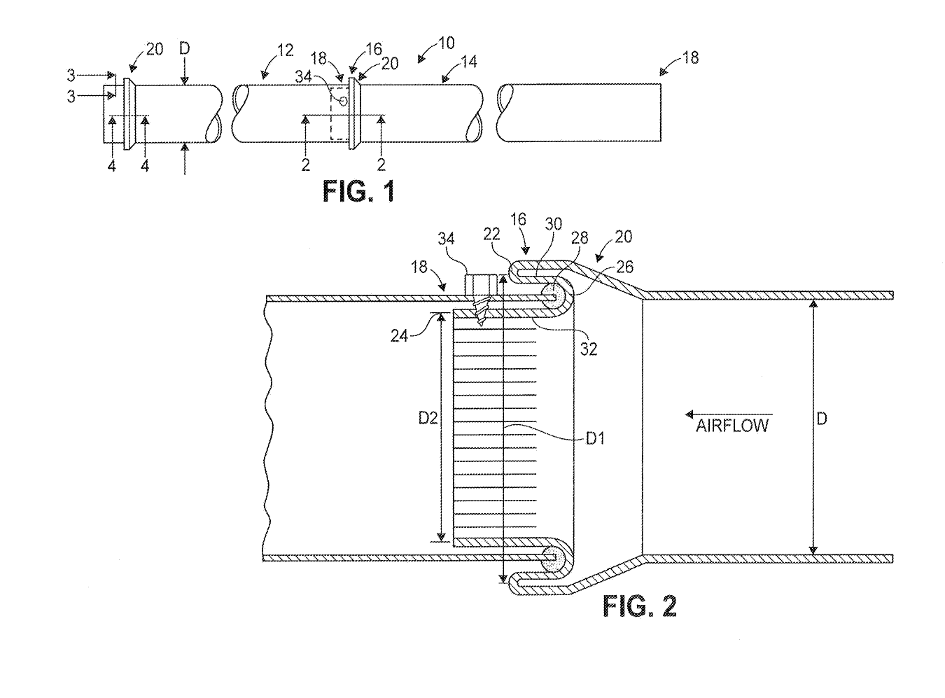

The invention will now be described with reference to the drawing figures, in which like reference numerals refer to like parts throughout. The notcher according to embodiments of the invention can be used in the formation of ducts, for example, such as the ducts illustrated in FIGS. 1-9 and disclosed in U.S. patent application Ser. No. 14/020,611, filed Sep. 6, 2013, the disclosure of which is incorporated by reference. As shown in FIG. 1, a pipe and fitting coupling system 10 includes a first pipe 12, a second pipe 14, and a joint 16. In addition to the straight pipes shown, the pipe and fitting coupling system 10 may include any suitable pipe and/or fitting known to those skilled in the art. Examples of suitable pipes and fittings include round and rectangular pipes, small and large radius elbow joints, ‘Y’ joints, ‘T’ joints, registers, and the like. Thus, for the sake of brevity, the term, “pipe 12” and “pipe 14” are used throughout the present disclosure and the figures depict a round pipe, however the embodiments are not limited to round pipes, but rather, the terms, “pipe 12” and “pipe 14” refer to round and rectangular pipe and fittings for the same.

To continue, the first pipe 12 has a pipe diameter D and a plain end 18. The second pipe has a receiving end 20. The receiving end is a single piece of shaped sheet metal. In general, the metal may include any suitable metal. Examples of suitable metals include steel, aluminum, alloys, and the like.

As shown in FIG. 2, the receiving end 20 includes a first axial flange 22, a second axial flange 24, an axial groove 26, and a sealant 28. In general, the axial flanges 22 and 24 facilitate positioning the plain end 18 in the axial groove 26. The first axial flange 22 has a first flange diameter D1 that is greater than the pipe diameter D. The second axial flange 24 has a second flange diameter D2 that is less than the pipe diameter D. The second axial flange 24 extends further axially than the first axial flange 22. As described herein, this axial extension of the second axial flange 22 facilitates securing the plain end 18 of the first pipe 12 in the receiving end 20 of the second pipe 14.

The axial groove 26 is disposed at the pipe diameter and between the first axial flange 22 and the second axial flange 24. To facilitate telescoping the plain end 18 into the receiving end, the first axial flange 22 has an inwardly angled face 30 to meet the axial groove 26 and the second axial flange 24 has an outwardly angled face 32 to meet the axial groove 26. These angled faces 30 and 32 simplify the task of aligning the two ends 18 and 20 and initiating the telescoping of the plain end 18 towards the axial groove 26. The sealant 28 is disposed in the axial groove 26 to seal the plain end 18 in the receiving end 20. The joint 16 is formed by the cooperative alignment of the plain end 18 being inserted into the receiving end 20 and being sealed by the sealant 28.

Also shown in FIGS. 1 and 2 is a fastener 34. As shown in FIG. 2, the fastener 34 is configured to pierce a wall of the plain end 18 and a wall of the second axial flange 24. In this manner, the plain end 18 may be secured in the receiving end 20.

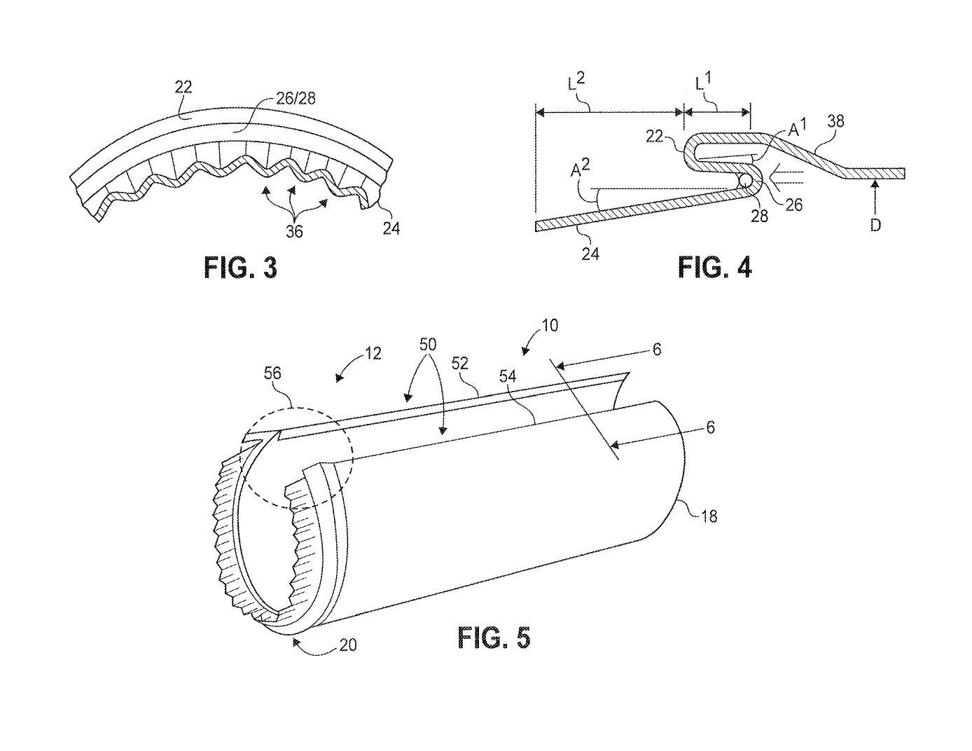

FIG. 3 is a cross-sectional view taken along line 3-3 of FIG. 1. As shown in FIG. 3, the second axial flange 24 includes a series of crimps 36 disposed about the circumference of the second axial flange 24. The series of crimps 36 are configured to provide a taper in the second axial flange 24.

FIG. 4 is a cross-sectional view taken along line 4-4 of FIG. 1. As shown in FIG. 4, the inwardly angled face 30 of the first axial flange 22 includes an angle A¹. The outwardly angled face 32 of the second axial flange 24 includes an angle A².

Also shown in FIG. 4, the first axial flange 22 extends a length L¹ past a bottom or proximal portion of the axial groove 26. The length L¹ includes any suitable length. The second axial flange 24 extend a length L² past a distal end of the first axial flange 22. In general, the length L² is to provide sufficient area to secure the fastener 34.

FIG. 5 is an isometric projection of the pipe 12 of FIG. 1. As shown in FIG. 5, the pipe 12 includes a longitudinal lock 50. The longitudinal lock 50 includes a male portion 52 and female portion 54. Also shown in FIG. 5 is an intersection zone 56 where the receiving end 20 (e.g., the transverse seal) intersects with the longitudinal lock 50. It is at this intersection zone 56 that the pipe and fitting coupling system 10 has the greatest tendency to leak. In order to offset this leakage tendency, additional sealant, such as the sealant 28, may be utilized as described herein.

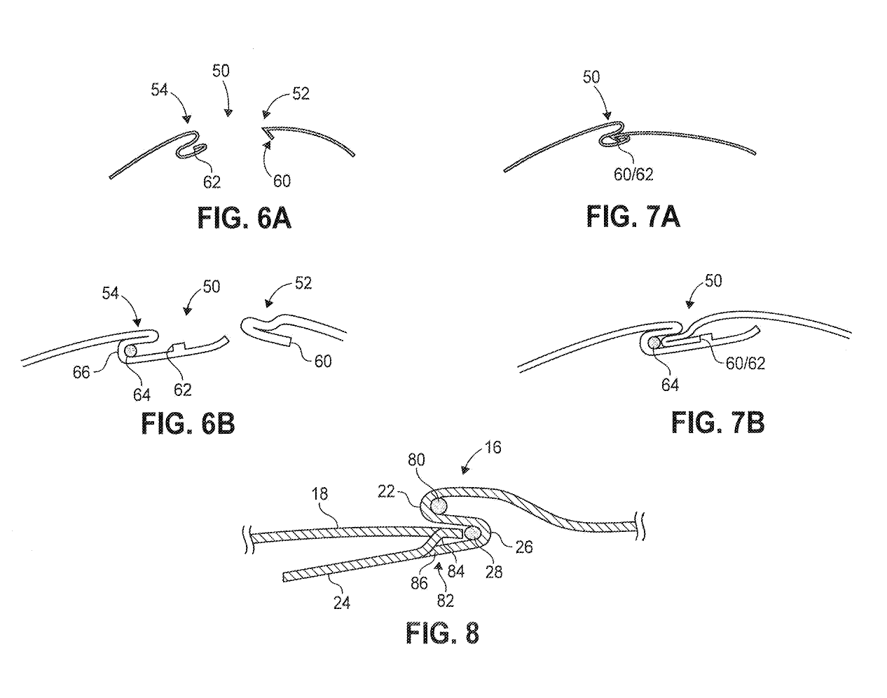

FIG. 6A is a cross-sectional view taken along line 6-6 of FIG. 5 in accordance with an embodiment of the invention. As shown in FIG. 6A, the male portion 52 includes a hem 60 and the female portion 54 includes a locking groove 62. As shown in FIG. 6B, in response to the male portion 52 being inserted sufficiently into the female portion 54, the hem 60 slides past the locking groove 62 and engages the locking groove 62 to secure the male portion 52 in the female portion 54.

FIG. 7A is a cross-sectional view taken along line 6-6 of FIG. 5 in accordance with another embodiment of the invention. As shown in FIG. 7A, the male portion 52 includes the hem 60 and the female portion 54 includes the locking groove 62. Alternatively, the longitudinal lock 50 may include a button lock. In addition, the female portion 54 includes a sealant 64 disposed in a channel 66. As shown in FIG. 7B, in response to the male portion 52 being inserted sufficiently into the female portion 54, the male portion 52 is pressed against the sealant 64 to form a seal and the hem 60 slides past the locking groove 62 and engages the locking groove 62 to secure the male portion 52 in the female portion 54.

FIG. 8 is a cross-sectional view taken along line 4-4 of FIG. 1 in a locked conformation in accordance with another embodiment of the invention. As shown in FIG. 8, the pipe and fitting coupling system 10 optionally includes a sealant 80 in a groove corresponding to the back side of the first axial flange 22. If included, the sealant 80 is configured to reduce or eliminate air leakage at the intersection zone 56. That is, by placing in the groove corresponding to the back side of the first axial flange 22, air leakage at the intersection zone 56 has been reduced based upon empirical testing.

Also shown in FIG. 8, the pipe and fitting coupling system 10 optionally includes a lock 82 disposed at the joint 16 configured to secure the plain end 18 in the receiving end 20. In general, the lock 82 includes any suitable locking structure(s) such as tabs, barbs, hems, locking grooves, buttons, dimples, hooks, catches, detents, and the like. In a particular example, the plain end 18 includes a hem 84 and the receiving end 20 includes a locking groove 86. In yet another example, the plain end 18 includes a series of the hems 84 or buttons, dimples, and the like spaced about the circumference and the receiving end includes a series of locking grooves or catches spaced about the circumference. In this manner, the lock 82 may be selectively engaged by rotating the plain end 18 relative to the receiving end 20.

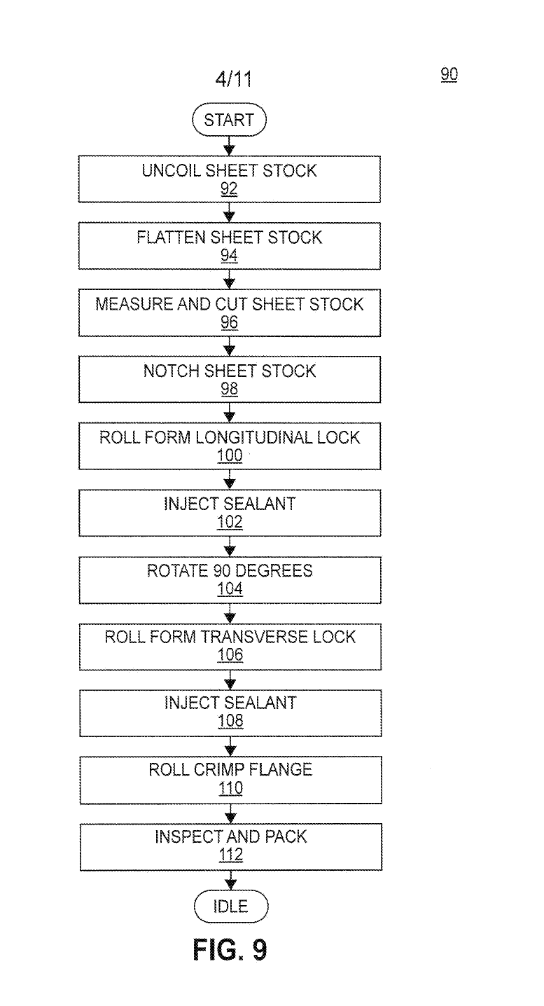

FIG. 9 is a flow diagram of a method 90 of fabricating the pipe and fitting coupling system of FIG. 1. In general, to fabricate a pipe such as the pipe 12 and 14, a supply of sheet metal is uncoiled with an uncoiler at step 92. The sheet metal is then flattened with a flattener to reduce the coil set, e.g., the tendency of the metal to coil at step 94. At step 96, the sheet metal is measured and cut to the predetermined dimensions by a shear, for example. A notcher removes segments of sheet metal that would otherwise interfere with the longitudinal or transverse locking mechanism at step 98. The notched sheet now travels to a conventional longitudinal lock former via a transfer table. At step 100, the sheet now receives the longitudinal lock 50 such as a “snap” lock shown in FIGS. 6A and 7A or “button” lock mechanism as shown in FIGS. 6B and 7B. One side is roll formed to a female lock, the other side to a male lock. While the locks are being formed, a sealant is injected into the female portion on the lock at step 102. Upon exiting the lock former, the pipe blank travels onto another transfer table that changes the direction of travel by 90 degrees at step 104. At step 106, the pipe blank enters a roll former configured to form the receiving end 20.

In general, structures such as flanges and grooves are formed in sheet stock by passing the stock through a series of rolls or dies. A first roll in the series may initiate a bend and subsequent rolls accentuate the structure. In order to fabricate the receiving end 20, the receiving end 20 is ‘flared’ or otherwise formed with a die and/or rolls to generate an outwardly angled face 38. In general, the outwardly angled face 38 increases the diameter of the pipe from the diameter D to the diameter D¹. Once the outwardly angled face 38 is formed, the first axial flange 22, the axial groove 26 and second axial flange 24 are formed by passing the receiving end 20 through one or a series of rolls or dies. Following step 106, the sealant 28 is injected or otherwise disposed in the axial groove 26 at step 108. The blank then travels to a crimper machine and the series of crimps 36 may be formed in the second axial flange 24 at step 110. Following fabrication, the completed pipe 12 exits onto a run-out table where it is inspected and then packaged at step 112.

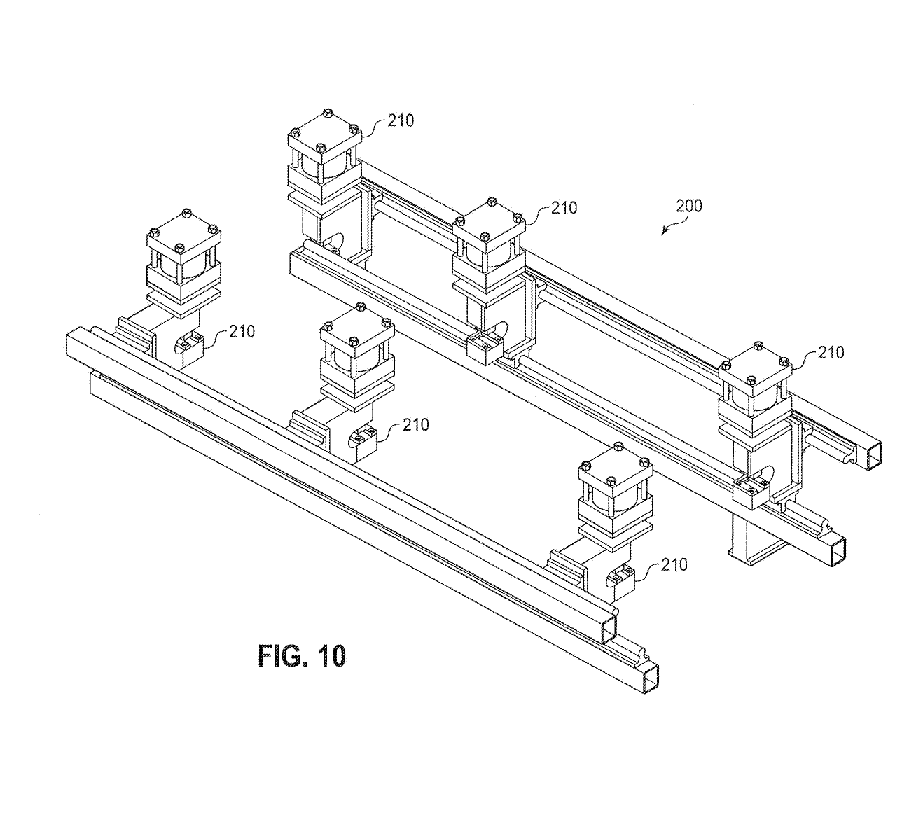

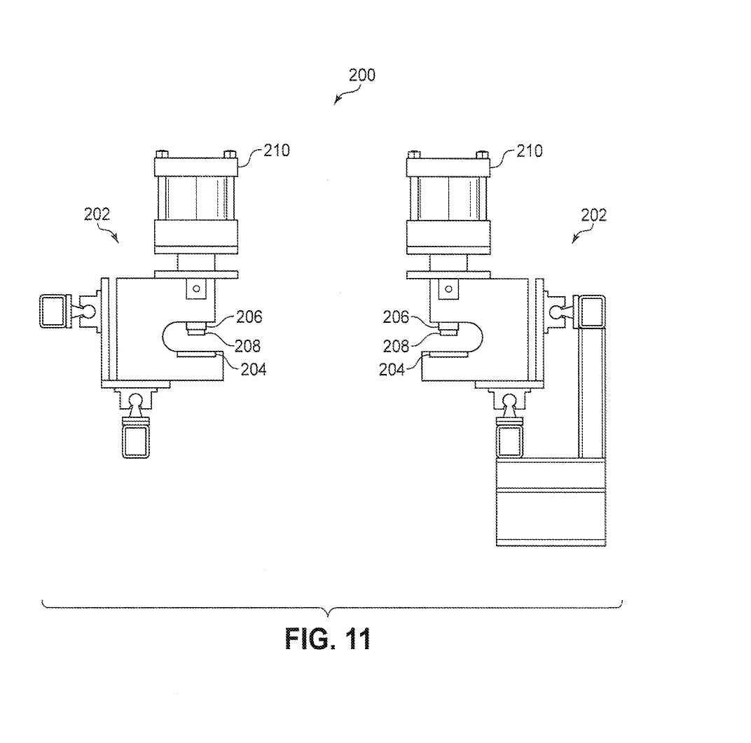

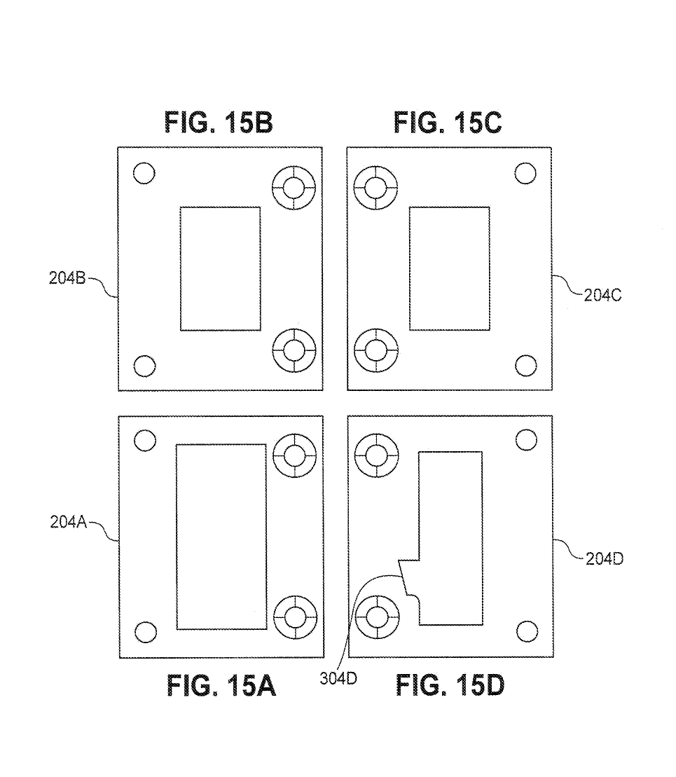

Embodiments of a notching machine discussed above with relation to step 98 is illustrated in FIGS. 10-16. Known prior art notchers rely on a pivot mechanism to move a notching arm with a notching die attached to pierce and cut the metal. The pivot arm is moved by a rod attached to a spring loaded air bladder that inflates to engage the notcher, and the spring pulls the pivot arm back to its original position after the notching process has occurred. These prior art notchers are prone to heavy wear and tear on the rubber bladder, pivot arm, pivot shaft and the pivot pin.

In the notching machine 200 illustrated in FIGS. 10-16, each notcher 202 includes a notching head 220 having a stationary die 204 and a punch or notching die 208. Notching die 208 is attached to a piston rod 206 and engages stationary die 204 to sever corner portions of a pipe blank. Rod 206 attached to notching die 208 is reciprocated up and down by a double acting air cylinder 210. On the down stroke, the notching die 208 pierces the pipe blank, and in the upstroke, the notching die 208 returns to its original position. The prior art rubber bladder, pivot arm, pivot shaft and the pivot pin which were prone to malfunction and wear and tear are not present in this design.

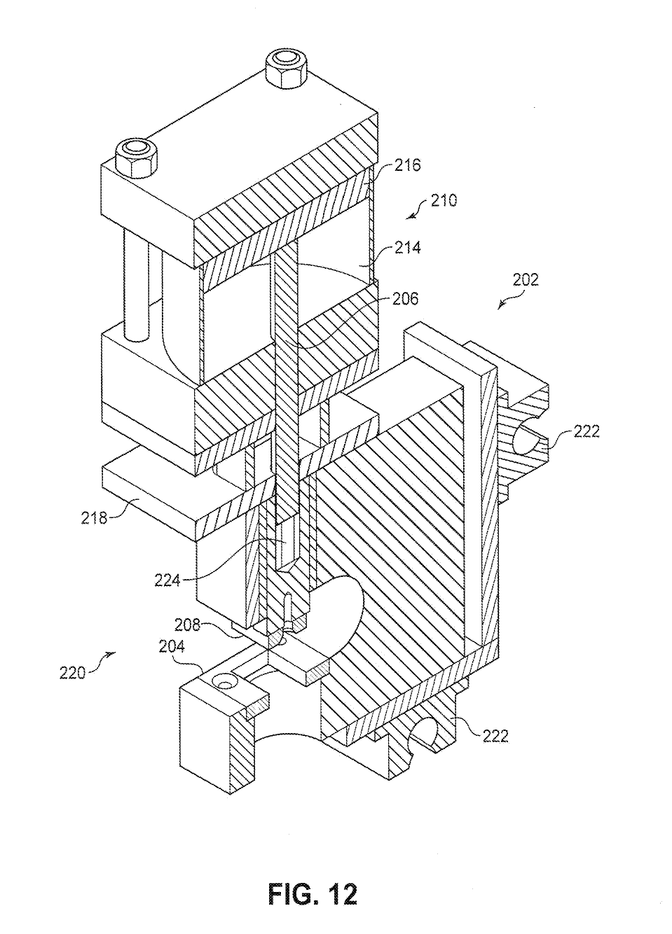

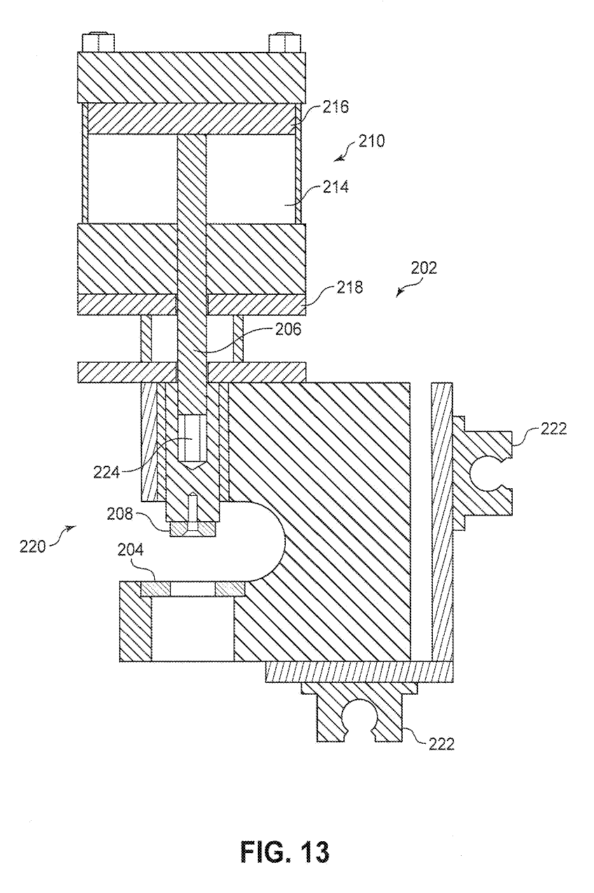

FIGS. 12 and 13 are cut-away views of the internal components of the notchers 202. On top is double acting air cylinder 210 having a cylinder body 214, a plunger 216 and the piston rod 206. A bracket 218 supports the cylinder 210 above the notching head 220. The piston rod 206 of the air cylinder 210 is connected to the notching die 208 by a hexagonal shaft 224. Double acting air cylinder 210 uses air pressure to both extend and retract piston rod 206. When pressurized, the air cylinder plunger 216 moves downward, pushing the notching die 208 through the sheet metal, piercing the desired shape out of the metal before retracting upward again.

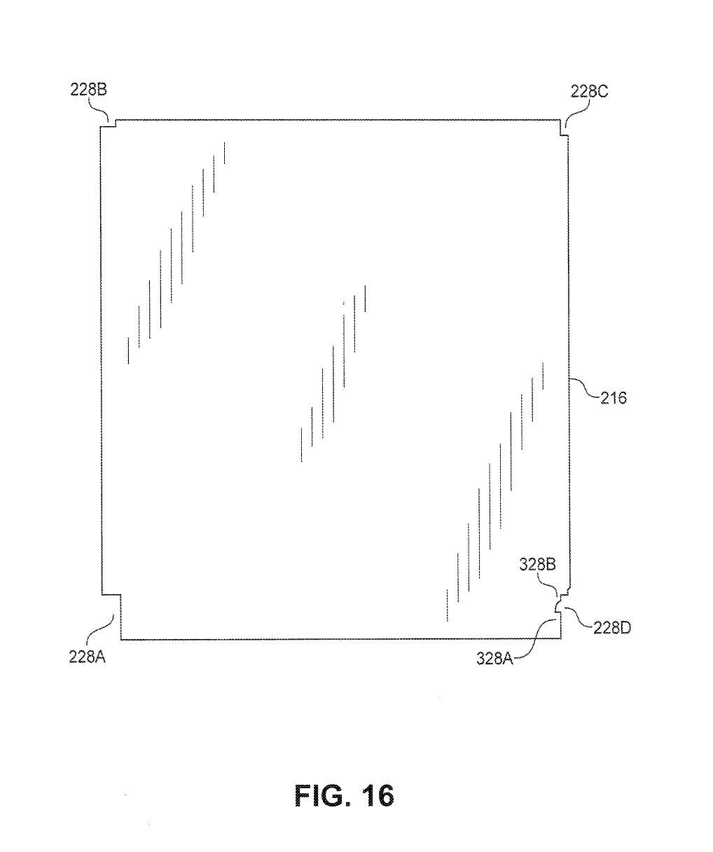

The notching machine 200 has a notcher 202 positioned to notch each of the four corners of the pipe blank 226 (FIG. 16). The notching machine 200 includes a table 212 having at least two notchers 202 and preferably three notchers 202 on each side of the table such that, on each side of table 212, two notchers 202 are spaced apart to accommodate different sizes of the pipe blank. Each notcher 202 is fastened to the frame of the notching table 212 by two clamps 222 in the back and the bottom of the notcher 202.

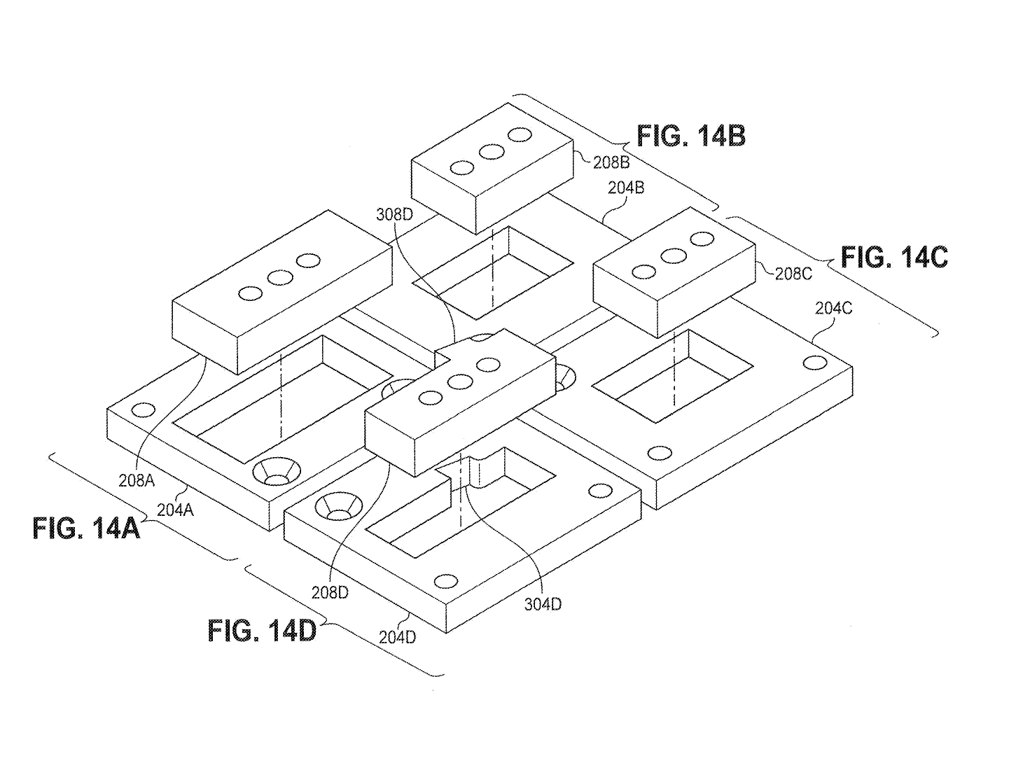

Referring to FIGS. 14A-16, the notching dies 208 (208A, 208B, 208C, 208D) and stationary dies 204 (204A, 204B, 204C, 204D) are arranged to notch the four corners of a pipe blank 226 as shown in FIG. 16 to form four notches (228A, 228B, 228C, 228D), respectively. Referring still to FIG. 16, the top end of the pipe blank 216 forms the female end of the finished duct/pipe, and the bottom end of the pipe blank 216 forms the male end of the finished duct/pipe.

Notching dies (208A, 208B, 208C) have rectangular shapes to pierce a rectangular notch, that correspond to notches 228A, 228B, 228C, respectively. The primary purpose of the rectangular notches is to remove any material that is not used to form the longitudinal lock. On the female end of the pipe, the notches serve to remove access material that might make it harder to join two pieces of pipe together on the transverse connection. Less of the female longitudinal lock is removed to allow the lock to contain sealant until the place where it is seated into the transverse channel. Stationary dies (204A, 204B, 204C) have cut-out rectangular shaped portion corresponding to the rectangular notching dies (208A, 208B, 208C).

Notches 228B and 228C have a rectangular shape and eliminate the overlap of several layers of steel in the longitudinal lock on the plain end 18 of the pipe making it easier to connect the pipe to another piece. If notches 228B and 228C were not cut, these edges that form the longitudinal lock on the plain end would create a substantial overlap of metal. This overlap of metal makes it more difficult to seat the plain (or female) end into the male end because of the added thickness and potential interference of the layer of overlapped metal.

Notching die 208A and stationary die 204A have rectangular shapes that are larger than the rectangular shapes of notching dies 208B, 208C and stationary dies 204B, 204C. Notch 228A formed has a rectangular shape larger than notches 228B and 228C. The larger notch 228A eliminates the female lock of the longitudinal seal on the crimp portion and seal on the receiving end 20 and accommodates the male end of the pipe. Here, the notch has to clear enough room for the length of the crimp and for the height of the transverse channel. A longitudinal seal is not required on the crimp portion, as the primary function of the crimp portion is to help guide a plain end into the axial groove 26, and therefore the edges of the crimp on the receiving end 20 do not need to be sealed together. If this portion of the blank were not removed, a longitudinal seal would be formed in this area which would interfere with the transverse channel.

Notching die 208D and stationary die 204D have a rectangular shape with a protrusions on one side 308D, 304D, resepectively, corresponding to notch 228D having two protrusions 328A and 328B (FIGS. 16). The lower part of dies 208D and 204D serve to cut the depth of the crimp which should not receive a longitudinal lock. The protrusion 328A above the crimp notch removes the depth of the transverse channel on an angle as to not interfere with the crimp and channel from the opposing side of the pipe. The remainder of the die creates a protrusion 328B forming a rounded tab that is used to line up the transverse lock sides before snapping the longitudinal lock.

The notcher 202 is not limited to notching the pipe described in FIGS. 9, and can be used with other notching dies for other purposes. Likewise, the notching dies described above could be used in other notchers as well.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A notching apparatus comprising:
a stationary die;
a notching die;
a rod connected to the notching die; and
a double acting air cylinder connected to the rod for reciprocating the rod and notching die, wherein the double acting air cylinder uses air pressure to both extend and retract the rod.

2. The notching apparatus of claim 1, wherein the rod is connected to the notching die by a hexagonal shaft.

3. A table comprising:
at least one notcher for notching sheet metal, wherein each of the at least one notcher comprises:
a stationary die;
a notching die;
a rod connected to the notching die; and
a double acting air cylinder connected to the rod for reciprocating the rod and notching die, wherein the double acting air cylinder uses air pressure to both extend and retract the rod.

4. The table of claim 3, wherein the table has two sides and there are at least two notchers on each side of the table for notching corners of a pipe blank.

5. The table of claim 4, wherein the table has two sides and there are three notchers on each side of the table to accommodate different sizes of a pipe blank.

6. The table of claim 4, wherein the stationary and notching dies are configured to notch corners of a pipe blank to accommodate transverse and longitudinal channels in the pipe blank when formed into a pipe.

7. The table of claim 4, wherein the stationary and notching dies are configured to notch rectangular shaped notches on three corners of the pipe blank and a rectangular shaped notch having at least one protrusion on one side on a fourth corner.

8. A method of making a pipe, comprising:
notching a pipe blank to form at least one first notch in a first end of the pipe blank;
notching a pipe blank to form at least one second notch in a second end of the pipe blank;
forming a female lock of a longitudinal seam on a first side of the pipe blank;
forming a male lock of a longitudinal seam on a second side of the pipe blank;
forming a transverse seam on the second end of the pipe blank;
wherein the at least one first and second notches eliminate overlapping metal of the longitudinal seam.

9. The method of claim 8, wherein notching a pipe blank to form at least one first notch includes notching first and second corners of the first end of the pipe blank.

10. The method of claim 9, wherein notching a pipe blank to form at least one first notch includes forming rectangular shaped notches in the first and second corners of the first end of the pipe blank.

11. The method of claim 8, wherein notching a pipe blank to form at least one second notch includes notching first and second corners of the second end of the pipe blank.

12. The method of claim 11, wherein notching a pipe blank to form at least one second notch includes forming a rectangular shaped notch in a first corner of the first end of the pipe blank.

13. The method of claim 12, wherein notching a pipe blank to form at least one second notch includes forming a rectangular shaped notch having at least one protrusion in the second corner of the first end of the pipe blank.

14. The method of claim 12, wherein notching a pipe blank to form at least one second notch includes forming a rectangular shaped notch having two one protrusions in the second corner of the first end of the pipe blank, wherein a first protrusion removes depth of the transverse seam and the second protrusion creates a rounded tab for aligning the transverse seam.
